(19) United States
(12) Patent Application Publication
(10) Pub. No.: US 2026/0099883 A1
(43) Pub. Date: Apr. 9, 2026

(54) GENERATIVE AI-BASED SYSTEM AND METHOD FOR CLAIM DATA PROCESSING AND EVALUATION

(71) Applicant: Cognizant Technology Solutions India Pvt. Ltd, Chennai (IN)

(72) Inventors: Debojyoti Hazra, Bangalore (IN); Latoya James, Burtonsville, MD (US); Mohamed Abdul Sattar, Bangalore (IN); Guruprasad Krishnadoss, Chennai (IN); Jigar Ashok Parikh, Mumbai (IN); Chandra Sekhar Dasika, Hyderabad (IN); Muniraju Bhadrappa, Bengaluru (IN); Milind Tilak, Mumbai (IN); Richa Chaudhary, Chandigarh (IN)

(21) Appl. No.: 19/174,284

(22) Filed: Apr. 9, 2025

Related U.S. Application Data
(60) Provisional application No. 63/704,052, filed on Oct. 7, 2024.

(51) Int. Cl. G06Q 40/08; G06F 40/103; G06F 40/205; G06N 3/042; G06N 3/0475; G06N 3/10

(52) U.S. Cl. CPC G06Q 40/08; G06F 40/205; G06N 3/042; G06N 3/0475; G06N 3/10; G06F 40/103

(57) ABSTRACT

A system and method for Gen AI based claim data processing and evaluation is provided. The present invention enables generating prompt data by processing parsed standard operation procedure data and rules data associated with a first set of pre-defined rules. The prompt data is provided as a first prompt data to a Large Language Model (LLM) to generate a set of first rules. Set of first rules is provided along with output generation instructions as a second prompt data to the LLM to generate a set of second rules. Non-adjudicated claims data is extracted along with corresponding non-automated edit codes for evaluation. An output is generated in the form of recommendations by validating non-adjudicated claims data and corresponding non-automated edit codes based on a comparison with set of second rules. The recommendations are provided for resolving the non-adjudicated claims data.

### FIELD OF THE INVENTION

The present invention relates generally to the field of data processing, and more particularly the present invention relates to a generative AI-based system and method for processing of healthcare claims data.

### BACKGROUND OF THE INVENTION

Claim evaluation, for example healthcare claims data evaluation, is a crucial process in healthcare industry that involves reviewing and evaluating complex claims data for determining validity, accuracy, and eligibility for reimbursement. It has been observed that claim evaluation processes are associated with inefficiencies and inaccuracies that lead may increased to resolution times, administrative burdens and higher operational costs. Also, existing claims processing systems entailing automated processes are not able to adequately process the claims data and a high percentage of claims data remains unprocessed. As such, in fact, a high volume of claims is manually reviewed, thereby increasing inaccuracies in claims processing due to complexity, unstructured data formats, frequent process changes, complex decision making, etc. Further, manual review of claims data requires large number of Full Time Equivalent (FTE)'s across healthcare industry.

Typically, in existing systems around 20-30 percent of claims data is evaluated manually that varies from platform to platform leading to increased Average Handling Time (AHT), as agents need to consult various Standard Operating Procedures (SOP) documents manually, which include rules for data validation and processing of the claims, to resolve edit codes (i.e., error codes) and warning messages associated with the claims data. Also, claim processing relates to high processing time and complex navigations for edit codes determination, thereby resulting in delayed claim processing. As such, overall Turn Around Time (TAT) and efficiency of claims processing is adversely affected. Also, manually going through lengthy SOP documents to resolve single or multiple edit codes associated with the claim leads to inaccuracies in claim processing. Further, in existing systems automated evaluation of claims data using a Robotic Process Automation (RPA) technique is employed to automate resolution of high volume of error codes and claim evaluation process involves resolving multiple edit codes. Traditional RPA processes typically have three stages, i.e., data extraction, business logic and posting that require huge effort, cost and time for scaling up the processes. Furthermore, automating claims evaluation process using RPA is a complex process as each of the edit codes have to be automated individually thereby increasing complexity.

In light of the above drawbacks, there is a need for a system and method for enhanced processing of healthcare claims data for increasing overall efficiency and reducing manual effort in healthcare claims evaluation workflows. There is a need for a system and method for reducing errors in healthcare claim evaluation workflows. Furthermore, there is a need for a system and a method for reducing claims resolution time, administrative burden, and operational costs.

### SUMMARY OF THE INVENTION

In various embodiments of the present invention, a system for Generative Artificial Intelligence (Gen AI) based claim data processing and evaluation is provided. The system comprises a memory storing program instructions, a processor executing the program instructions stored in the memory and a Gen AI based data processing engine executed by the processor. The Gen AI based data processing engine generates prompt data by processing parsed Standard Operation Procedure (SOP) data and rules data associated with a first set of pre-defined rules. The Gen AI based data processing engine provides the prompt data as a first prompt data to a Large Language Model (LLM) to generate a set of first rules. The Gen AI based data processing engine provides the set of first rules along with one or more output generation instructions as a second prompt data to the LLM to generate a set of second rules. The set of second rules is employed for evaluating one or more non-adjudicated claims data. The non-adjudicated claims data is extracted along with corresponding one or more non-automated edit codes from an adjudication unit for evaluation. The Gen AI based data processing engine generates an output in the form of one or more recommendations by validating the non-adjudicated claims data and the corresponding non-automated edit codes based on a comparison with the set of second rules. The recommendations are provided to the adjudication unit for resolving the non-adjudicated claims data.

In various embodiments of the present invention, a method for Gen AI based claim data processing and evaluation is provided. The method is implemented by a processor executing instructions stored in a memory. The method comprises generating prompt data by processing parsed SOP data and rules data associated with a first set of pre-defined rules. The method comprises providing the prompt data as a first prompt data to a LLM to generate a set of first rules. The method comprises providing the set of first rules along with one or more output generation instructions as a second prompt data to the LLM to generate a set of second rules. The set of second rules is employed for evaluating one or more non-adjudicated claims data, the non-adjudicated claims data is extracted along with corresponding one or more non-automated edit codes from an adjudication unit for evaluation. The method comprises generating an output in the form of one or more recommendations by validating the non-adjudicated claims data and the corresponding non-automated edit codes based on a comparison with the set of second rules. The recommendations are provided to the adjudication unit for resolving the non-adjudicated claims data.

In various embodiments of the present invention, a computer program product is provided. The computer program product comprises a non-transitory computer-readable medium having computer program code stored thereon, the computer-readable program code comprising instructions that, when executed by a processor, causes the processor to generate prompt data by processing parsed SOP data and rules data associated with a first set of pre-defined rules. The prompt data is provided as a first prompt data to a LLM to generate a set of first rules. The set of first rules is provided along with one or more output generation instructions as a second prompt data to the LLM to generate a set of second rules. The set of second rules is employed for evaluating one or more non-adjudicated claims data. The non-adjudicated claims data is extracted along with corresponding one or more non-automated edit codes from an adjudication unit for evaluation. An output is generated in the form of one or more recommendations by validating the non-adjudicated claims data and the corresponding non-automated edit codes based on a comparison with the set of second rules. The recommendations are provided to the adjudication unit for resolving the non-adjudicated claims data.

### BRIEF DESCRIPTION OF THE ACCOMPANYING DRAWINGS

The present invention is described by way of embodiments illustrated in the accompanying drawings wherein:

FIG. 1 is a block diagram of a generative artificial intelligence-based system for claim data processing and evaluation, in accordance with an embodiment of the present invention;

FIG. 2A illustrates a screenshot of a Graphical User Interface (GUI) depicting a list of non-adjudicated claims data, FIG. 2B illustrates the a screenshot of GUI depicting generated recommendation along with a set of pre-defined rule checklists with one or more remarks, and FIG. 2C illustrates a screenshot of the GUI depicting one or more remarks indicating failed application of pre-defined rules, in accordance with an embodiment of the present invention;

FIGS. 3 and 3A illustrate a flowchart depicting a method for generative artificial intelligence-based claim data processing and evaluation, in accordance with an embodiment of the present invention; and

FIG. 4 illustrates an exemplary computer system in which various embodiments of the present invention may be implemented.

### DETAILED DESCRIPTION OF THE INVENTION

The present invention discloses a system and a method for a Generative Artificial Intelligence (Gen AI) based processing of healthcare claims data for increasing overall efficiency and reducing manual effort in healthcare claims evaluation workflows. The present invention discloses a system and a method for reducing errors in complex healthcare claim data evaluation workflows. Further, the present invention discloses a system and a method for adequately processing non-adjudicated claims data by employing prompt engineering techniques and Large Language Models (LLMs). Furthermore, the present invention discloses a system and a method for reducing claims resolution time, administrative burden, and operational costs.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

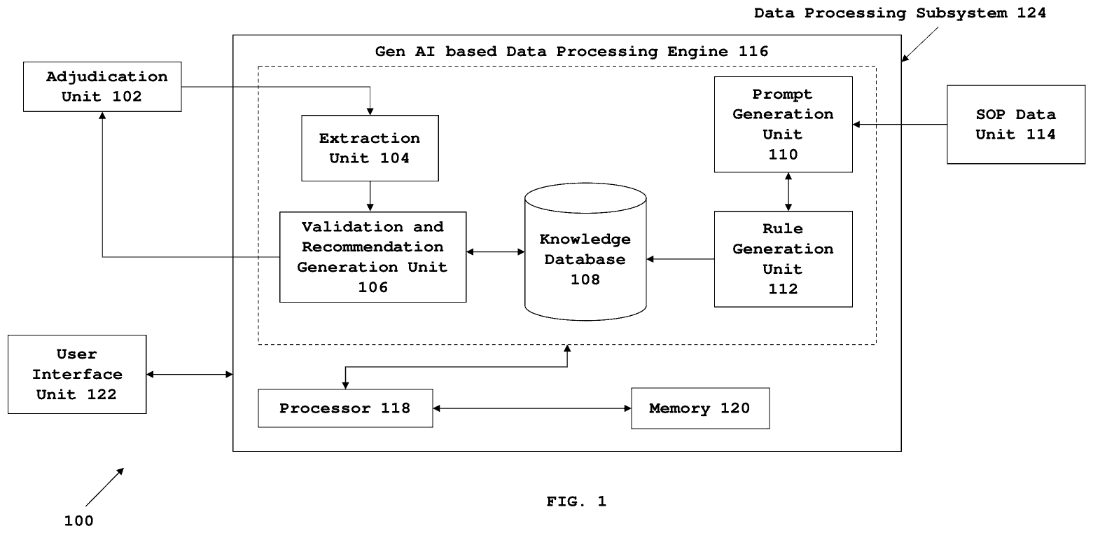

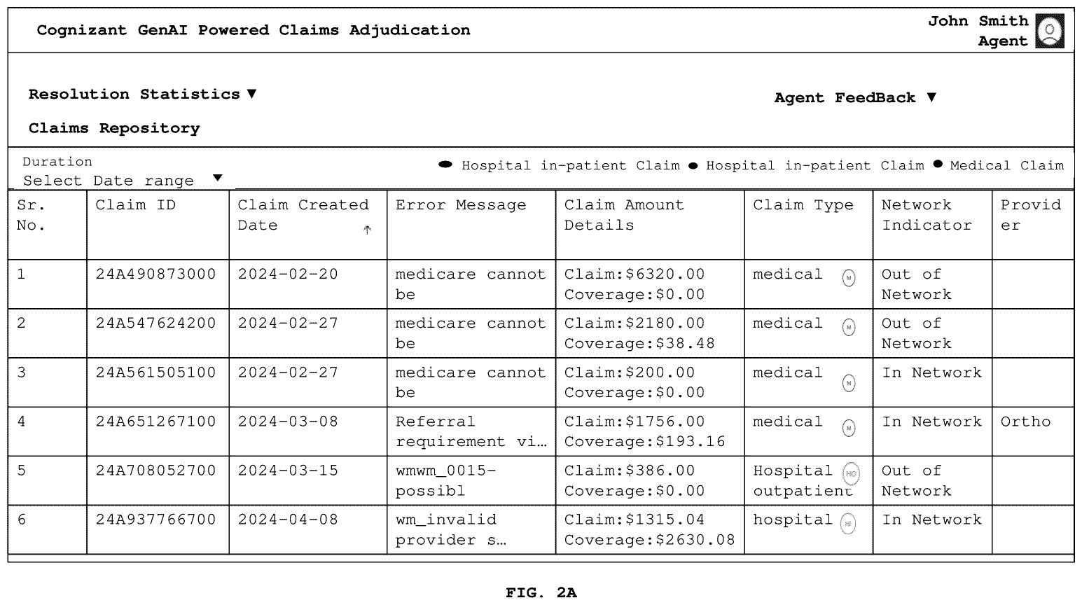

FIG. 1 is a block diagram of a system 100 for claim data processing and evaluation, in accordance with various embodiments of the present invention. In an embodiment of the present invention, the system 100 is a Gen AI based platform for automated processing and evaluation of non-adjudicated claims data and generating recommendations for resolving non-adjudicated claim data. In an embodiment of the present invention, the system 100 comprises an adjudication unit 102, a Standard Operating Procedures (SOP) data unit 114, a data processing subsystem 124 and a user interface unit 122. The adjudication unit 102, the SOP data unit 114, and the user interface unit 122 are connected to the subsystem 124 via a Representational State Transfer Application Programming Interface (REST API).

In an embodiment of the present invention, the data processing subsystem 124 comprises a Gen AI based-data processing engine 116 (engine 116), a processor 118, and a memory 120. In various embodiments of the present invention, the engine 116 has multiple units which work in conjunction with each other for Gen AI based claim data processing and evaluation. The various units of the engine 116 are operated via the processor 118 specifically programmed to execute instructions stored in the memory 120 for executing respective functionalities of the units of the engine 116 in accordance with various embodiments of the present invention.

In an embodiment of the present invention, the subsystem 124 may be implemented in a cloud computing architecture in which data, applications, services, and other resources are stored and delivered through shared data centres. In an exemplary embodiment of the present invention, the functionalities of the subsystem 124 are delivered to a user as Software as a Service (Saas) or Platform as a Service (PaaS) over a communication network.

In another embodiment of the present invention, the subsystem 124 may be implemented as a client-server architecture. In this embodiment of the present invention, a client terminal accesses a server hosting the subsystem 124 over a communication network. The client terminals may include but are not limited to a smart phone, a computer, a tablet, microcomputer or any other wired or wireless terminal. The server may be a centralized or a decentralized server. The server may be located on a public/private cloud or locally on a particular premise.

In an embodiment of the present invention, the Gen AI based-data processing engine 116 comprises an extraction unit 104, a validation and recommendation generation unit 106, a knowledge database 108, a prompt generation unit 110 and a rule generation unit 112. In an embodiment of the present invention, the Gen AI based-data processing engine 116 is a platform agnostic system capable of communicating with one or more external platforms.

The adjudication unit 102 performs evaluation of claims related to healthcare domain for resolution by processing healthcare claims data received from various users based on pre-defined configurations. In an exemplary embodiment of the present invention, the adjudication unit 102 may be a claim adjudication platform. The claim adjudication platform is an adjudication system which is used to process claims which includes activities such as receiving, validating and adjudicating claims which are submitted by healthcare providers by applying complex rules like payer and provider validations, authorization, etc. Further, if benefits, the adjudication unit 102 is unable to fully process the claims data automatically, then one or more pre-defined non-automated edit codes associated with one or more non-adjudicated claims data are identified. The pre-defined non-automated edit codes represent an error message signifying non-adjudicated claims data. The non-adjudicated claims data represents unresolved claims data.

In an embodiment of the present invention, the prompt generation unit 110 is configured to fetch Standard Operation Procedure (SOP) data along with associated one or more edit codes from the SOP data unit 114. The SOP data represents a pre-defined series of steps and corresponding resolution steps for resolving the claims data. In an exemplary embodiment of the present invention, the pre-defined series of steps includes checking date of service, procedure code, etc. rendering output such as ‘pay’, ‘deny’, and ‘pending (pend)’ for the claims data. An example of the SOP data associated with healthcare claims data is provided herein below, in accordance with an embodiment of the present invention:

| Step | Action | | |
|---|---|---|---|
| 1 | Review claim submission and make necessary corrections as per a | | |
| | claim image if required | | |
| 2 | Review the claim ultra-blue messages; is the claim denying as | | |
| | not authorized? | | |
| | If | Then | |
| | Yes | Move to next step | |
| | No | Continue normal processing | |
| 3 | Review claim history: is there a paid hospital claim on file for | | |
| | the Date of Service? | | |
| | If | And | Then |
| | Yes | Paid hospital | Note the hospital |
| | | claim is an | claim ID# and move |
| | | encounter claim | to step 5 |
| | Yes | Paid claim is | Note the hospital |
| | | not an encounter | pre-authorization |
| | | claim | number |
| | | | Move to step 5 |
| | No | N/A | Move to next step |
| 4 | Review Prospective UM; | | |
| | Is there a hospital authorization on file for date of service? | | |
| | If | And | Then |
| | No | N/A | Allow adjudication |
| | | | unit 102 to deny |
| | | | the affected claim |
| | | | line (s) |
| | Yes | It is in disallowed | Allow adjudication |
| | | status | unit 102 to deny |
| | | | affected claim |
| | | | line (s) |
| | Yes | Claim is submitted | Move to step 5 |
| | | with POS 21 or 31 | |
| | Yes, and | Approved authorization | Select authorization |
| | claim is | is available with | Update the claim |
| | submitted | POS 21 with matching | notes. |
| | with POS | criteria | Claim Note: POS 21 |
| | 51 or 61 | | preauthorization |
| | | | can be considered |
| | | | to process |
| | | | medical claims in |
| | | | POS 51 or 61 |
| | Yes, and | Hospital authorization | Update the workflow |
| | claim is | is in pending status | notes - “Hospital |
| | submitted | | Authorization # |
| | with POS | | is in pending |
| | 21, 31, 51 | | status. Claim |
| | or 61 | | routed to UM for |
| | | | review”. |
| | | | Route the claim |
| | | | to Queue: CCI_UM |
| | | | Role: UM Pending Auth |

| | |
|---|---|
| 5 | Access override screen and override preauthorization requirement |
| | on the affected claim line (s) with Explanation code 036 - Line |
| | level pre-authorization requirement bypassed. |
| 6 | Press OK |
| 7 | Update the claim notes as below: |
| | If hospital claim was paid |
| | “Hospital preauthorization available in prospective UM. |
| | Overriding the preauthorization requirement warning message |
| | on claim”. |
| 8 | Press F3 to Save |
| 9 | Press F4 to Adjudicate |

In an embodiment of the present invention, the prompt generation unit 110 parses the SOP data and rules data associated with the first set of pre-defined rules prior to generating prompt data. The SOP data is labelled. In an exemplary embodiment of the present invention, the SOP data is labelled by highlighting the text present in SOP data with a pre-defined color, which is parsed by the prompt generation unit 110. The prompt generation unit 110 employs one or more parsers such as custom python parsers for parsing the labelled SOP data. In an embodiment of the present invention, the prompt generation unit 110 employs one or more prompt engineering techniques to generate the prompt data. The prompt data is specifically generated by embedding knowledge related to the industry domain (e.g., healthcare domain).

In an embodiment of the present invention, the rule generation unit 112 receives the prompt data comprising the SOP data and the rules data from the prompt generation unit 110. The prompt data is provided as a first prompt data in the form of an input to a Large Language Model (LLM) associated with the rule generation unit 112 to generate a set of first rules. The set of first rules is converted to a comprehensive natural language format using NLP techniques and further missing clauses are also included to the set of first rules. In an exemplary embodiment of the present invention, the set of first rules is generated by employing NLP techniques. The set of first rules is generated in a human readable format. The rule generation unit 112 adds missing clauses to the set of first rules, removes irrelevant clauses and fine tunes the set of first rules. In an exemplary embodiment of the present invention, the LLM includes, but is not limited to, GPT-4®, Gemini®, and GPT-4o®.

In an embodiment of the present invention, the rule generation unit 112 inputs the generated set of first rules along with one or more output generation instructions as a second prompt data to the LLM associated with the rule generation unit 112 to generate a set of second rules. The output generation instructions cause the LLM to comprehend the set of first rules in a pre-defined manner for generating a specific output. For example, in the event no output is present for failure clause of a condition, then the output generation instructions are provided for the failure clause to follow the subsequent rule. Further, output generation instructions cause the LLM to generate the set of second rules in a pre-defined format as pre-set by the rule generation unit 112 for easy ingestion by the validation and recommendation generation unit 106. The pre-defined format may include, but is not limited to, JSON format. Further, the prompts are generated by leveraging various prompt engineering techniques such as, re-iteration, emphasis, etc. The set of second rules is generated in a JavaScript Object Notation (JSON) format (also referred as JSON rules). In an exemplary embodiment of the present invention, the set of second rules include specific field mappings corresponding to the edit codes associated with the claims data. The field mappings are carried out by mapping the SOP data to the set of first rules and mapping the set of first rules to the set of second rules. In an embodiment of the present invention, a separate set of second rules is generated for each edit code. Further, a transaction may have a combination of multiple edit codes as well. Also, one edit code may be applicable for multiple claims, and one claim can have one or more edit codes as well. In an example, one edit code may be applicable to hundred claims, and one claim can have two or three edit codes as well. The rule generation unit 112 stores the generated set of second rules in the knowledge database 108 in a JSON format for effective storage and retrieval. In an embodiment of the present invention, an individual JSON file is created for each of the edit codes and the JSON file comprises the one or more set of second rules to be applied for processing the non-adjudicated claims data. Further, the set of first rules and the set of second rules are generated by the rule generation unit 112 as a pre-processing step (i.e., as a one-time activity). An exemplary illustration of the SOP data, set of first rules and set of second rules is provided herein below:

Sample SOP Data

Current claim (“Claim ID” Line level data) & “History claim”
(HistoryLineInformation) has Multiple lines with the Non-Duplicate
lines
(Changes from the “Charges” or “Rev” or “Diagnosis” or “Units” or
Modifier (First 5 digit on the “Proc” is Proc and last 2 digit are
Modifier when the “Proc” code has 7 Digit) or “Additional Modifiers”
(First 5 digit on the “Proc” is Proc and last 2 digit are Modifier
when the “Proc” code has 7 Digit also “Additional Modifier” column
should be considered for Modifier) (From Line Level Data) or COB)
(“Insurance Type” & “Order” from the Claim Level Data) to “Charges”
or “RevCode” or “DxCode” or “Units” or Modifier (First 5 digit on
the “Proc” is Proc and last 2 digit are Modifier when the “Proc” code
has 7 Digit) or “Additional Modifiers” (From HistoryLineInformation)
or COB (“Insurance Type” and “Order” on the HistoryClaimInformation)
for the same “From Date” & “To Date” on the Line level data to “From
Date” & “To Date” on the HistoryLineInformation
AND
Payable Modifier (from Line Level data and HistoryLineInformation
any of the modifiers ((“Proc” (first 5 digit is Proc code and next 2
digit is Modifier) or “Additional Modifiers” (multiple modifiers
separated by comma))) to be compared with “CEVM_MODIFIER” (from
Modifier List sheet), and “Informational/Payable” (from Modifier List
sheet) is Payable).
IfThen
YesPay the claim bypassing the Duplicate Edit
NoMove to step 17

Set of First Rules

```
Step 16:
Rule Name: Non-Duplicate Lines Check
Rule:
1) Condition Name: Non-Duplicate Lines Check
  Condition: Current claim (“Claim ID” Line level data) & “History
claim” (HistoryLineInformation) has Multiple lines with the Non-
Duplicate lines (Changes from the “Charges” or “Rev” or “Diagnosis”
or “Units” or Modifier (First 5 digit on the “Proc” is Proc and last
2 digit are Modifier when the “Proc” code has 7 Digit) or “Additional
Modifiers” (First 5 digit on the “Proc” is Proc and last 2 digit are
Modifier when the “Proc” code has 7 Digit also “Additional Modifier”
column should be considered for Modifier) (From Line Level Data) or
COB) (“Insurance Type” & “Order” from the Claim Level Data) to
“Charges” or “RevCode” or “DxCode” or “Units” or Modifier (First 5
digit on the “Proc” is Proc and last 2 digit are Modifier when the
“Proc” code has 7 Digit) or “Additional Modifiers” (From
HistoryLineInformation) or COB (“Insurance Type” and “Order” on the
HistoryClaimInformation) for the same “From Date” & “To Date” on the
Line level data to “From Date” & “To Date” on the
HistoryLineInformation AND Payable Modifier (from Line Level data
and HistoryLineInformation any of the modifiers ((“Proc” (first 5
digit is Proc code and next 2 digit is Modifier) or “Additional
Modifiers” (multiple modifiers separated by comma))) to be compared
with “CEVM_MODIFIER” (from Modifier List sheet), and
IF Yes: Pay the claim bypassing the Duplicate Edit
    IF No: Move to “Rule Name: Check Claim Status and Allowed
Amount”
```

Set of Second Rules

```
{
    “RuleName”: “NonDuplicateLinesCheck”,
        “Expression”: “(((input1.lineleveldata.charges !=
input1.historylineinformation.charges) || (input1.lineleveldata.rev
!= input1.historylineinformation.revcode) ||
(input1.lineleveldata.diagnosis !=
input1.historylineinformation.dxcode) ||
(input1.lineleveldata.units != input1.historylineinformation.units)
|| (((input1.lineleveldata.proc.length >= 7 &&
input1.historylineinformation.proc.length >=7) ?
(input1.lineleveldata.proc.substring(5,2) !=
input1.historylineinformation.proc.substring(5,2)) : false) ||
(!(input1.lineleveldata.proc.length == 5 &&
input1.historylineinformation.proc.length ==5))) ||
(!(input1.lineleveldata.additionalmodifiers.ToLower( ).Split(‘,’).Al
l(value
=>input1.historylineinformation.additionalmodifiers.ToLower( ).Split
(‘,’).Any(hValue => hValue.Equals(value))) &&
input1.historylineinformation.additionalmodifiers.ToLower( ).Split(‘
,’).All(value => input1.lineleveldata.additionalmodifier
ToLower( ).Split(‘,’).Any(lValue => lValue.Equals(value))))) ||
((input1.claimleveldata.insurancetype !=
input1.historyclaiminformation.insurancetype) &&
(input1.claimleveldata.order !=
input1.historyclaiminformation.order))) &&
((input1.lineleveldata.fromdate ==
input1.historylineinformation.fromdate) &&
(input1.lineleveldata.todate ==
input1.historylineinformation.todate)) &&
((input1.lineleveldata.proc.Length >= 7 ?
(input1.modifierlist.cevm_modifier.ContainsKey(input1.lineleveldata
.proc.Substring(5, 2)) &&
input1.modifierlist.cevm_modifier[input1.lineleveldata.proc.Substri
ng(5, 2)] == \“payable\”) : false) ||
(input1.lineleveldata.additionalmodifiers.Split(‘,’).Any(value =>
input1.modifierlist.cevm_modifier.ContainsKey(value) &&
input1.modifierlist.cevm_modifier[value] == \“payable\”))) &&
((input1.historylineinformation.proc.Length >= 7 ?
(input1.modifierlist.cevm_modifier.ContainsKey(input1.historylinein
formation.proc.Substring(5, 2)) &&
input1.modifierlist.cevm_modifier[input1.historylineinformation.pro
c.Substring(
5, 2)] == \“payable\”) : false) ||
(input1.historylineinformation.additionalmodifiers.Split(‘,’).Any(v
alue => input1.modifierlist.cevm_modifier.ContainsKey(value) &&
input1.modifierlist.cevm_modifier[value] == \“payable\”))))”,
    “Actions”: {
      “OnSuccess”: {
        “Name”: “ActionOutput”,
        “Context”: {
          “Workflownote”: “Pay the claim bypassing the Duplicate
Edit”
        }
      },
      “OnFailure”: {
        “Name”: “EvaluateRule”,
        “Context”: {
          “WorkflowName”: “Facets Hospital Claims PPO: WM0015_{—}
Possible Duplicates”,
          “ruleName”: “CheckClaimStatusAndAllowedAmount”
        }
      }
    }
  }
```

In another embodiment of the present invention, extraction unit 104 is configured to extract the non-adjudicated claims data along with corresponding non-automated edit codes from the adjudication unit 102. In an exemplary embodiment of the present invention, the extraction unit 104 is configured to carry out the extraction based on a second set of pre-defined rules using Robotic Process Automation (RPA) and/or an Application Programming Interface (API). The extracted non-adjudicated claims data is provided as an input to the validation and recommendation generation unit 106, which may be in a structured or unstructured format. In another embodiment of the present invention, the extraction unit 104 is configured to fetch data from external platforms or databases related to one or more claim adjudication process. In the event of failing to fetch data for evaluating the non-adjudicated claims data, the extraction unit 104 is configured to add a blank field while sending instructions to the validation and recommendation generation unit 106.

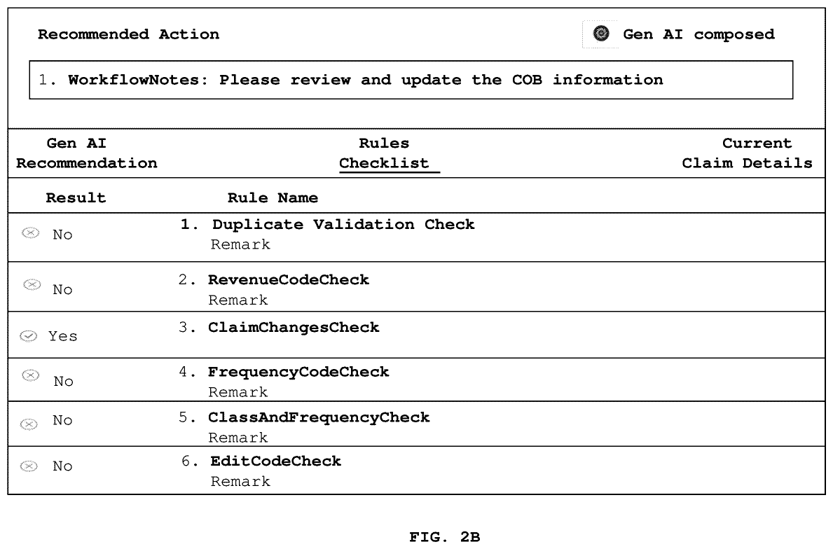

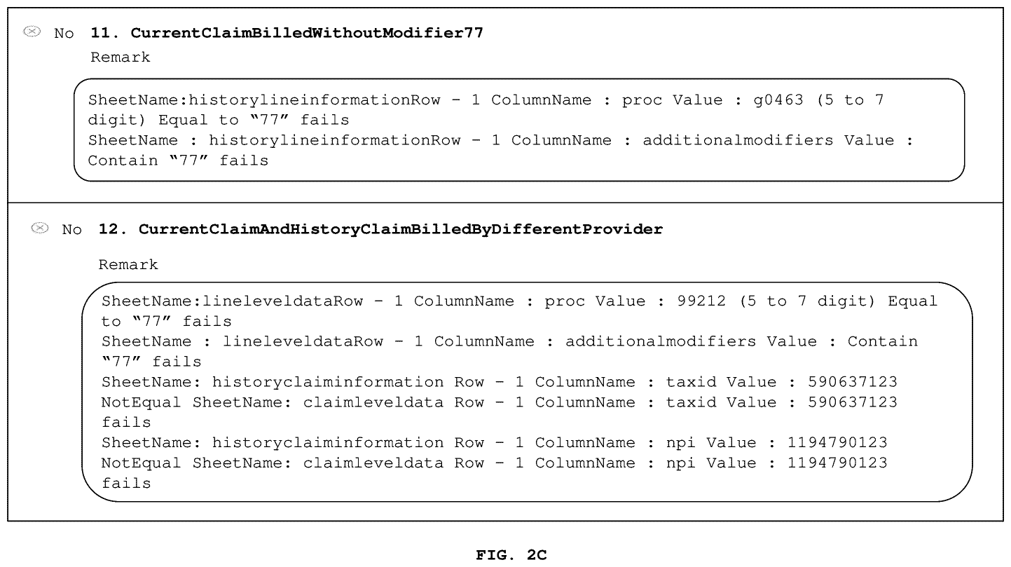

In an embodiment of the present invention, the validation and recommendation generation unit 106 fetches the set of second rules from the knowledge database 108, the non-adjudicated claims data and the corresponding non-automated edit codes from the extraction unit 104 for generating recommendations with respect to the non-adjudicated claims data by employing Gen AI techniques. The validation and recommendation generation unit 106, firstly, compares the non-adjudicated claims data and all the corresponding non-automated edit codes with the set of second rules for validating the non-adjudicated claims data. The validated non-adjudicated claims data is stored in a stack form in the knowledge database 108. The validation and recommendation generation unit 106, secondly, generates an output in the form of one or more recommendations based on the validated non-adjudicated claims data using a python post processing technique, which provides a configurable list of priority actions. The recommendations comprise one or more reasons for failure in resolving or processing the non-adjudicated claims data along with a sequence of action steps for resolving the non-adjudicated claims data. The recommendations further comprises a second set of pre-defined rule checklists with one or more remarks, as illustrated in FIGS. 2A, 2B and 2C and summary of the recommendations provided in a consolidated form, which has a configurable list of priority actions. The one or more remarks relates to final actions to be performed such as ‘pay the claim’, ‘modify the claim’ or ‘deny the claim’, etc. In an example, in order to provide claim recommendations by aggregating results of each of the non-automated edit codes, the validation and recommendation generation unit 106 provides the list of priority actions such as priority 1: deny the claim, priority 2: pending (pend) claims, and priority 3: pending claims and sets overall claim status to ‘deny’ as its priority supersedes the ‘pay’ priority.

In an embodiment of the present invention, the validation and recommendation generation unit 106 provides the recommendations to the adjudication unit 102 using the API or RPA for resolving the non-adjudicated claims data. The recommendations are further rendered on a Graphical User Interface (GUI) of the user interface unit 122 for receiving a feedback from the user with respect to the generated recommendations. The feedback is processed for fine-tuning the rule generation unit 112 by using a supervised active learning technique for refining the generation of recommendations. The validation and recommendation generation unit 106 stores the recommendations in the form of training data and utilises the stored data to refine the generation of recommendations in subsequent iterations of the non-adjudicated claims data resolution.

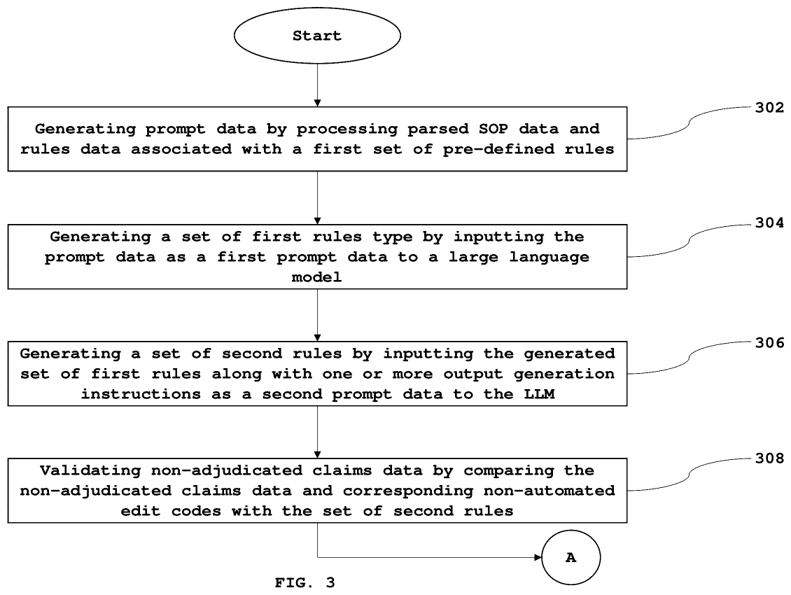

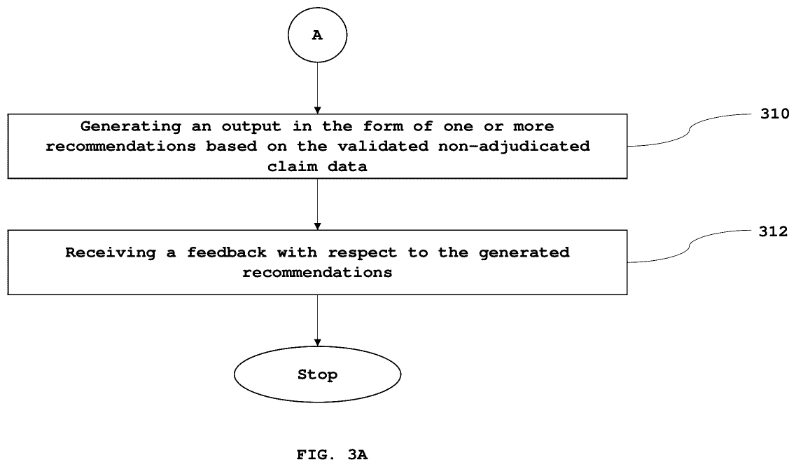

FIGS. 3 and 3A illustrate a flowchart depicting a method for Gen AI-based claim data processing and evaluation, in accordance with an embodiment of the present invention.

At step 302, prompt data is generated by processing parsed SOP data and the rules data associated with a first set of pre-defined rules. In an embodiment of the present invention, SOP data is fetched along with associated one or more edit codes. The SOP data represents a pre-defined series of steps and corresponding resolution steps for resolving healthcare claims data. In an exemplary embodiment of the present invention, the SOP data includes the pre-defined series of steps including checking date of service, procedure code, etc. rendering output such as ‘pay’, ‘deny’, and ‘pending (pend)’ for the claims data. In an embodiment of the present invention, the SOP data and the rules data are parsed prior to generating prompt data. The SOP data is labelled. In an exemplary embodiment of the present invention, the SOP data is labelled by highlighting the text present in SOP data with a pre-defined color, which is subsequently parsed. Further, one or more parsers are employed such as custom python parsers for parsing the labelled SOP data. In an exemplary embodiment of the present invention, the prompt data is generated by employing one or more prompt engineering techniques. The prompt data is specifically generated by embedding knowledge related to the industry domain (e.g., healthcare domain).

At step 304, a set of first rules is generated by inputting the prompt data as a first prompt data to an LLM. In an embodiment of the present invention, the set of first rules is converted to a comprehensive natural language format using NLP techniques and further missing clauses are also included to the set of first rules. In an exemplary embodiment of the present invention, the set of first rules is generated by employing NLP techniques. The set of first rules are generated in a human readable format. Further, missing clauses are added in the set of first rules, removes irrelevant clauses and the set of first rules is fine tuned. In an exemplary embodiment of the present invention, the LLM includes, but is not limited to, GPT-4®, Gemini®, and GPT-4o®.

At step 306, a set of second rules is generated by inputting the generated set of first rules along with one or more output generation instructions as second prompt data to the LLM. In an embodiment of present invention, the output generation instructions cause the LLM to comprehend the set of first rules in a pre-defined manner for generating a specific output. For example, in the event no output is present for failure clause of a condition, then the output generation instructions are provided for the failure clause to follow the subsequent rule. Further, output generation instructions cause the LLM to generate the set of second rules in a pre-defined format as pre-set for easy ingestion. The pre-defined format may include, but is not limited to, JSON format. Further, the prompts are generated by leveraging various prompt engineering techniques such as re-iteration, emphasis, etc. The set of second rules is generated in a JSON format (also referred as JSON rules). In an embodiment of the present invention, the set of second rules include specific field mappings corresponding to the edit codes associated with the claims data. The field mappings are carried out by mapping the SOP data to the set of first rules and mapping the set of first rules to the set of second rules. In an embodiment of the present invention, a separate set of second rules is generated for each edit code. Further, a transaction may have a combination of multiple edit codes as well. Also, one edit code may be applicable for multiple claims, and one claim can have one or more edit codes as well. In an example, one edit code may be applicable to hundred claims and one claim can have two or three edit codes as well. An individual JSON file may be created for each of the edit codes and the JSON file comprises the set of second rules to be applied for processing the non-adjudicated claims data.

In an embodiment of the present invention, the non-adjudicated claims data is extracted along with corresponding non-automated edit codes. The non-adjudicated claim data corresponding to the non-automated edit codes is extracted based on a second set of pre-defined rules using an RPA and/or an API. In another embodiment of the present invention, data is fetched from external platforms or databases related to one or more claim adjudication process. In the event of failure to fetch data for evaluating the non-adjudicated claims data, a blank field is added.

At step 308, non-adjudicated claims data is validated by comparing the non-adjudicated claims data and corresponding non-automated edit codes with the set of second rules. In an embodiment of the present invention, the non-adjudicated claims data and the corresponding non-automated edit codes are compared with the set of second rules for validating the non-adjudicated claims data.

At step 310, an output is generated in the form of one or more recommendations based on the validated non-adjudicated claim data. In an embodiment of the present invention, the recommendations comprise one or more reasons for failure in resolving or processing the non-adjudicated claims data along with sequence of action steps for resolving the non-adjudicated claims data. The recommendations further comprises the second set of pre-defined rule checklists with one or more remarks and summary of the recommendation provided in a consolidated form, which has a configurable list of priority actions. The one or more remarks relates to final actions to be performed such as ‘pay the claim’, ‘modify the claim’ or ‘deny the claim’, etc. In an example, in order to provide claim recommendations by aggregating results of each of the non-automated edit codes, the validation and recommendation generation unit 106 provides the list of priority actions such as priority 1: deny the claim, priority 2: pending (pend) claims, and priority 3: pending claims and sets overall claim status to ‘deny’ as its priority supersedes the ‘pay’ priority.

At step 312, a feedback is received with respect to the generated recommendations. In an embodiment of the present invention, the recommendations are rendered on a GUI for receiving the feedback from the user with respect to the generated recommendations. The feedback is processed for refining the generation of recommendations.

Advantageously, in various embodiments of the present invention, an enhanced processing of claims data (e.g., healthcare, etc.) is provided by implementing Gen AI techniques for reducing manual adjudication of claims data, thereby minimizing errors in complex claims data evaluation workflows and maintaining context of the claims data. The present invention provides for adequately processing non-adjudicated claims data in a flexible manner by employing LLMs for generating recommendations for resolving non-adjudicated claims data in an efficient manner. Further, the present invention provides for reducing claims resolution time, administrative burden, and operational costs.

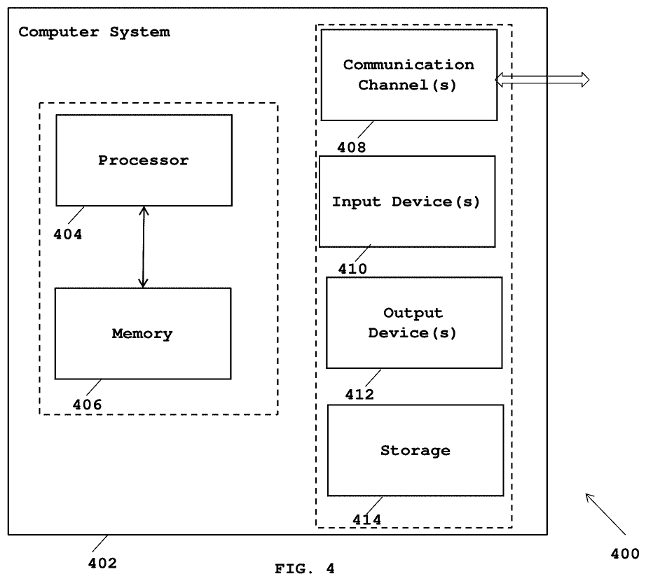

FIG. 4 illustrates an exemplary computer system in which various embodiments of the present invention may be implemented. The computer system 402 comprises a processor 404 and a memory 406. The processor 404 executes program instructions and is a real processor. The computer system 402 is not intended to suggest any limitation as to scope of use or functionality of described embodiments. For example, the computer system 402 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 406 may store software for implementing an embodiment of the present invention. The computer system 402 may have additional components. For example, the computer system 402 includes one or more communication channels 408, one or more input devices 410, one or more output devices 412, and storage 414. An interconnection mechanism (not shown) such as a bus, controller, or network, interconnects the components of the computer system 402. In an embodiment of the present invention, operating system software (not shown) provides an operating environment for various software executing in the computer system 402 and manages different functionalities of the components of the computer system 402.

The communication channel(s) 408 allow communication over a communication medium to various other computing entities. The communication medium information such provides as program instructions, or other data in a communication media. The communication media includes, but not limited to, wired or wireless methodologies implemented with an electrical, optical, RF, infrared, acoustic, microwave, Bluetooth or other transmission media.

The input device(s) 410 may include, but not limited to, a keyboard, mouse, pen, joystick, trackball, a voice device, a scanning device, touch screen or any another device that is capable of providing input to the computer system 402. In an embodiment of the present invention, the input device(s) 410 may be a sound card or similar device that accepts audio input in analog or digital form. The output device(s) 412 may include, but not limited to, a user interface on CRT or LCD, printer, speaker, CD/DVD writer, or any other device that provides output from the computer system 402.

The storage 414 may include, but not limited to, magnetic disks, magnetic tapes, CD-ROMs, CD-RWs, DVDs, flash drives or any other medium which can be used to store information and can be accessed by the computer system 202. In an embodiment of the present invention, the storage 414 contains program instructions for implementing the described embodiments.

The present invention may suitably be embodied as a computer program product for use with the computer system 402. The method described herein is typically implemented as a computer program product, comprising a set of program instructions which is executed by the computer system 402 or any other similar device. The set of program instructions may be a series of computer readable codes stored on a tangible medium, such as a computer readable storage medium (storage 414), for example, diskette, CD-ROM, ROM, flash drives or hard disk, or transmittable to the computer system 402, via a modem or other interface device, over either a tangible medium, including but not limited to optical or analogue communications channel(s) 408. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from the scope of the invention.

We claim:

1. A system for Generative Artificial Intelligence (Gen AI) based claim data processing and evaluation, the system comprising:
a memory storing program instructions;
a processor executing the program instructions stored in the memory; and
a Gen AI based data processing engine executed by the processor and configured to:
generate prompt data by processing parsed Standard Operation Procedure (SOP) data and rules data associated with a first set of pre-defined rules;
provide the prompt data as a first prompt data to a Large Language Model (LLM) to generate a set of first rules;
provide the set of first rules along with one or more output generation instructions as a second prompt data to the LLM to generate a set of second rules, wherein the set of second rules is employed for evaluating one or more non-adjudicated claims data, the non-adjudicated claims data is extracted along with corresponding one or more non-automated edit codes from an adjudication unit for evaluation; and
generate an output in the form of one or more recommendations by validating the non-adjudicated claims data and the corresponding non-automated edit codes based on a comparison with the set of second rules, wherein the recommendations are provided to the adjudication unit for resolving the non-adjudicated claims data.

2. The system as claimed in claim 1, wherein the Gen AI based data processing engine comprises a prompt generation unit executed by the processor and is configured to fetch the SOP data along with edit codes and the rules data from a SOP data unit, and wherein the SOP data represents a pre-defined series of steps and corresponding resolution steps for resolving the claims data.

3. The system as claimed in claim 2, wherein the prompt generation unit parses the SOP data and the rules data to generate the first prompt data by employing one or more prompt engineering techniques, and wherein the SOP data is labelled by highlighting the text present in SOP data with a pre-defined color.

4. The system as claimed in claim 1, wherein the data processing engine comprises a rule generation unit executed by the processor and is configured to convert the set of first rules to a comprehensive natural language format using natural language processing techniques, and wherein the set of first rules is generated by employing NLP techniques, and wherein the rule generation unit adds missing clauses to the set of first rules, removes irrelevant clauses and fine tunes the set of first rules.

5. The system as claimed in claim 4, wherein the set of second rules is generated by the rule generation unit in a JavaScript Object Notation (JSON) format, and wherein the set of second rules includes field mappings corresponding to one or more edit codes associated with the claims data, the field mappings are carried out by mapping the SOP data to the set of first rules and mapping the set of first rules to the set of second rules, and wherein an individual JSON file is created for each of the edit codes, the JSON file comprises the set of second rules to be applied for processing the non-adjudicated claims data along with corresponding non-automated edit codes.

6. The system as claimed in claim 1, wherein the data processing engine comprises an extraction unit executed by the processor and configured to extract the non-adjudicated claims data along with corresponding non-automated edit codes based on a second set of pre-defined rules using robotic process automation and/or an application program interface.

7. The system as claimed in claim 1, wherein the data processing engine comprises a validation and recommendation generation unit executed by the processor and is configured to fetch the set of second rules from a knowledge database, and the non-adjudicated claims data and all the corresponding non-automated edit codes are fetched from an extraction unit for generating the recommendations by employing one or more Gen AI techniques,

8. The system as claimed in claim 7, wherein recommendations are provided based on the validated non-adjudicated claims data using a python post processing technique, which provides a configurable list of priority actions, and wherein the recommendations comprise one or more reasons for failure in resolving or processing the non-adjudicated claims data along with sequence of action steps for resolving the non-adjudicated claims data, and wherein the recommendations comprise a second set of pre-defined rule checklists with one or more remarks and summary of the recommendations provided in a consolidated form, which has a configurable list of priority actions.

9. The system as claimed in claim 8, wherein the validation and recommendation generation unit provides the recommendations to the adjudication unit using robotic process automation and/or an application program interface for resolving the non-adjudicated claims data, and wherein the recommendations are rendered on a graphical user interface of a user interface unit for receiving a feedback from users with respect to the generated recommendations, the feedback is processed by the data processing engine for fine-tuning a rule generation unit by using supervised active learning technique which modifies and refines the recommendations.

10. A method for Generative Artificial Intelligence (Gen AI) based claim data processing and evaluation, the method is implemented by a processor executing instructions stored in a memory, the method comprises:
generating prompt data by processing parsed Standard Operation Procedure (SOP) data and rules data associated with a first set of pre-defined rules;
providing the prompt data as a first prompt data to a Large Language Model (LLM) to generate set of first rules;
providing the set of first rules along with one or more output generation instructions as a second prompt data to the LLM to generate a set of second rules, and wherein the set of second rules is employed for evaluating one or more non-adjudicated claims data, the non-adjudicated claims data is extracted along with corresponding one or more non-automated edit codes from an adjudication unit for evaluation; and
generating an output in the form of one or more recommendations by validating the non-adjudicated claims data and the corresponding non-automated edit codes based on a comparison with the set of second rules, wherein the recommendations are provided to the adjudication unit for resolving the non-adjudicated claims data.

11. The method as claimed in claim 10, wherein the SOP data and the rules data are parsed to generate the first prompt data by employing one or more prompt engineering techniques, and wherein the SOP data is labelled by highlighting text present in the SOP data with a pre-defined color.

12. The method as claimed in claim 10, wherein the set of first rules is converted to a comprehensive natural language format using natural language processing techniques, and wherein the set of first rules is generated by employing NLP techniques, and wherein missing clauses are added to the set of first rules, irrelevant clauses are removed and the set of first rules are fine-tuned.

13. The method as claimed in claim 10, wherein the set of second rules is generated in a JavaScript Object Notation (JSON) format, and wherein the set of second rules includes field mappings corresponding to one or more edit codes associated with the claims data, the field mappings are carried out by mapping the SOP data to the set of first rules and mapping the set of first rules to the set of second rules, and wherein an individual JSON file is created for each of the edit codes, the JSON file comprises the set of second rules to be applied for processing the non-adjudicated claims data along with corresponding non-automated edit codes.

14. The method as claimed in claim 10, wherein the non-adjudicated claims data corresponding to the non-automated edit codes are extracted based on a second set of pre-defined rules using robotic process automation and/or an application program interface.

15. The method as claimed in claim 10, wherein the recommendations comprise one or more reasons for failure in resolving or processing the non-adjudicated claims data along with sequence of action steps for resolving the non-adjudicated claims data, and wherein the recommendations are rendered via a graphical user interface for receiving a feedback from users with respect to the generated recommendations, the feedback is processed by the data processing for fine-tuning by using supervised active learning technique which modifies and refines the recommendations.

16. A computer program product comprising:
a non-transitory computer-readable medium having computer program code stored thereon, the computer-readable program code comprising instructions that, when executed by a processor, causes the processor to:
generate prompt data by processing parsed Standard Operation Procedure (SOP) data and rules data associated with a first set of pre-defined rules;
provide the prompt data as a first prompt data to a Large Language Model (LLM) to generate a set of first rules;
provide the set of first rules along with one or more output generation instructions as a second prompt data to the LLM to generate a set of second rules, wherein the set of second rules is employed for evaluating one or more non-adjudicated claims data, and wherein the non-adjudicated claims data is extracted along with corresponding one or more non-automated edit codes from an adjudication unit for evaluation; and
generate an output in the form of one or more recommendations by validating the non-adjudicated claim data and the corresponding non-automated edit codes based on a comparison with the set of second rules, wherein the recommendations are provided to the adjudication unit for resolving the non-adjudicated claims data.
